(19) United States
(12) Patent Application Publication
(10) Pub. No.: US 2010/0322555 A1
(43) Pub. Date: Dec. 23, 2010

(54) Grating Structures for Simultaneous Coupling to TE and TM Waveguide Modes

(75) Inventors: Diedrik Vermeulen, Sint-Pauwels (BE); Gunther Roelkens, Melle (BE); Dries Van Thourhout, Gent (BE)

Correspondence Address: MCDONNELL BOEHNEN HULBERT & BERGHOFF LLP, 300 S. WACKER DRIVE, 32ND FLOOR, CHICAGO, IL, 60606, US

(73) Assignees: IMEC, Leuven (BE); UNIVERSITEIT GENT, Gent (BE)

(21) Appl. No.: 12/820,878

(22) Filed: Jun. 22, 2010

Related U.S. Application Data
(60) Provisional application No. 61/219,231, filed on Jun. 22, 2009.

(51) Int. Cl. G02B 6/26; G02B 6/34

(52) U.S. Cl. 385/28; 385/37

(57) ABSTRACT

Disclosed are an integrated optical coupler, and a method of optically coupling light, between an optical element and at least one integrated optical waveguide. The optical coupler includes a grating structure and is adapted for coupling light to waveguide modes with different polarization with low polarization dependent loss. For example, polarization dependent loss may be smaller than 0.5 dB. The waveguide modes may include a Transverse Electric (TE) waveguide mode and a Transverse Magnetic (TM) waveguide mode. The optical coupler may further include a two-dimensional grating structure adapted for providing polarization splitting for a first optical signal of a first predetermined wavelength and for coupling both polarizations forward or backward.

### CROSS-REFERENCE TO RELATED APPLICATIONS

The present application claims priority to U.S. Provisional Application No. 61/219,231 filed in the United States Patent and Trademark Office on Jun. 22, 2009, the entire contents of which is incorporated herein by reference.

### FIELD

This invention relates to integrated optical components and methods of operating the same. More specifically it relates to integrated optical grating couplers for simultaneous coupling to TE and TM waveguide modes.

### BACKGROUND

Photonic integrated circuits hold the potential of creating low cost, compact optical functions. The application fields in which they can be applied are very diverse and include: telecommunication and data communication applications, sensing, signal processing, etc. These optical circuits comprise optical elements such as light sources, optical modulators, spatial switches, optical filters, photodetectors, etc., the optical elements being interconnected by optical waveguides. Silicon photonics is emerging as one of the most promising technologies for low cost integrated circuits for optical communication systems. Silicon photonics are CMOS-process compatible and due to the available high refractive index contrast, it is possible to create very compact devices.

However, coupling of light between an optical element such as for example an optical fiber and an optical waveguide, e.g. an optical waveguide on a silicon chip, is challenging because of the large mismatch in mode-size between the integrated nanophotonic waveguides (typically 0.1 μm²) and standard single mode fibers (typically 100 μm²). This may lead to high coupling losses, for example in the order of 20 dB. Therefore, there is a great interest in improving the coupling efficiency between an optical waveguide circuit and an optical fiber or more in general for improving the coupling efficiency between an integrated optical waveguide and an optical element (e.g. light source, modulator, optical amplifier, photodetector) or between an integrated optical waveguide and free space.

Different technologies are presented in the literature to enhance the coupling efficiency between an integrated optical waveguide and an optical fiber.

One possible solution is a lateral coupler using spot size conversion with an inverse taper, in combination with a tapered or lensed optical fiber. Although this technique allows broadband and polarization independent coupling, the 1 dB alignment tolerances are very small (typically about 0.3 μm). Moreover, this approach requires cleaved and polished facets to couple light into the optical circuit. This excludes its use for wafer-scale optical testing of the optical functions, and may lead to a high cost.

In order to improve the coupling efficiency to a standard single mode fiber in a high refractive index contrast system, and in order to relax the alignment accuracy of an optical fiber and to allow for wafer scale testing, one-dimensional grating structures have been proposed. These structures allow direct physical abutment from the top or bottom side of the optical waveguide circuit with a standard single mode optical fiber, while the diffraction grating directs the light into the optical waveguide circuit (or vice versa). The performance of these one-dimensional gratings is critically dependent on the polarization of the light. Typically, only a single polarization at a certain wavelength can be efficiently coupled between the integrated optical waveguide and an optical fiber, resulting in a very polarization dependent operation of the one-dimensional grating coupler. As in typical applications this polarization is unknown and varying over time, the applicability of the one-dimensional grating structures may be limited. In cases where a polarization maintaining fiber is used or where a polarization scrambling approach is adopted, these one-dimensional gratings can be used. Also in the case where the one-dimensional grating structure is used to optically couple an integrated light source, generating, processing or detecting light with a known and fixed polarization, these devices can be used.

In order to circumvent the problem of polarization sensitivity, a two-dimensional grating coupler structure has been proposed (U.S. Pat. No. 7,065,272), which comprises two optical waveguides intersecting at a substantially right angle and a two-dimensional diffractive grating structure created at the intersection. When the diffractive grating is physically abutted with a single mode optical fiber, a polarization split is obtained that couples orthogonal modes from the single-mode optical fiber into identical modes in the first and second waveguide. While the ratio of coupled optical power between both optical waveguides is still dependent on the polarization of the incident light, this two-dimensional fiber coupling structure can be used in a polarization diversity approach, in order to achieve a polarization independent integrated circuit. As compared to one-dimensional grating couplers, such two-dimensional polarization splitting couplers suffer from smaller coupling efficiencies (typically 10% to 20% smaller) and a smaller bandwidth. The coupling efficiency of two-dimensional grating couplers is very sensitive to the position of the optical fiber. For example, the tolerance in fiber position may be in the sub-micrometer range.

In WO2008/122607 an integrated optical coupler is described that can be used for optically multiplexing or demultiplexing light of substantially different wavelengths, based on a diffraction grating structure. This integrated optical multiplexer can for example be used as a duplexer, wherein optical signals centered around two distinct wavelengths or wavelength bands can be coupled between an optical fiber and an optical waveguide. The grating structure may be a one-dimensional or a two-dimensional structure. In case of a one-dimensional grating structure, the performance of the coupler/duplexer is dependent on the light polarization. In case of a two-dimensional grating structure, a polarization splitting can be performed, such that polarization independent integrated optical circuits can be obtained.

When using a two-dimensional grating coupler, a polarization split is obtained that couples orthogonal modes form the single-mode optical fiber into identical modes in two waveguides. Therefore, the polarization is the same for these waveguides, i.e. either TE polarization for each waveguide or TM polarization for each waveguide.

### SUMMARY

It is an object of the present disclosure to provide efficient systems and methods for coupling radiation with different polarization.

The present disclosure relates to an integrated optical coupler for coupling light between an optical element and at least one integrated optical waveguide, wherein the optical coupler comprises a grating structure and wherein the optical coupler is adapted for coupling light to waveguide modes with different polarization with low polarization dependent loss. The optical coupler may be adapted through adaptation of the grating and a prescribed orientation of the optical fiber and the integrated optical waveguide.

The optical coupler may be adapted for coupling light to waveguide modes with different polarization with a polarization dependent loss smaller than 0.5 dB.

The present disclosure also relates to an integrated optical coupler for coupling light between an optical element and at least one integrated optical waveguide, wherein the optical coupler comprises a grating structure and wherein the optical coupler is adapted for coupling light to waveguide modes with different polarization with substantially the same coupling efficiency. The coupling efficiency between different polarizations may differ less than 0.5 dB.

The optical coupler as described above may be adapted for coupling light to at least one Transverse Electric (TE) waveguide mode and at least one Transverse Magnetic (TM) waveguide mode.

The optical coupler as described above may be adapted for coupling light in a single direction into the waveguide.

The optical coupler as described above may be adapted for coupling different waveguide modes in different directions.

The optical coupler as described above may comprise a one-dimensional grating structure and may be adapted for providing polarization splitting for an optical signal of a first predetermined wavelength, thereby maintaining orthogonal polarizations in the integrated optical waveguide. Such an optical coupler may be adapted for providing a good coupling efficiency for both TE and TM polarizations and a 1 dB bandwidth larger than 50 nm. Such an optical coupler may be adapted for providing multiplexing and/or polarization splitting of a second optical signal of a second predetermined wavelength substantially different from the first predetermined wavelength, thereby maintaining orthogonal polarizations for the second predetermined wavelength in the integrated optical waveguide. In addition to polarization splitting of an optical signal of a first predetermined wavelength, such an optical coupler also may be adapted for coupling of a linearly TE or TM polarized optical signal of a third wavelength and/or of a linearly TE or TM polarized optical signal of a fourth wavelength.

The optical coupler as described above may comprise a two-dimensional grating structure and may be adapted for providing polarization splitting for a first optical signal of a first predetermined wavelength and for coupling both polarizations forward or backward. Such an optical coupler furthermore may be adapted for providing polarization splitting for a second optical signal of a second predetermined wavelength and for coupling both polarizations for the second optical signal in the same direction as the first optical signal of the first predetermined wavelength. Such an optical coupler may be adapted for simultaneously supporting a TE waveguide mode and a TM waveguide mode in the at least one integrated optical waveguide. Such an optical coupler may comprise a focusing grating. Such an optical coupler may provide a coupling area having a characteristic size larger than 10 micrometer.

The optical coupler as described above may comprise a non-uniform grating.

The optical coupler as described above may be integrated in an integrated photonics circuit comprising the at least one integrated optical waveguide.

The present disclosure also relates to a method for optically coupling light between an optical element and at least one integrated optical waveguide, the method comprising coupling light to waveguide modes with different polarization with low polarization dependent loss. The method may comprise providing polarization splitting using a one-dimensional grating for an optical signal of a first predetermined wavelength, thereby maintaining orthogonal polarizations in the integrated optical waveguide. The method may comprise providing polarization splitting for a first optical signal of a first predetermined wavelength and coupling both polarizations forward or coupling both polarizations backward, using a two dimensional grating. The method furthermore may comprise providing polarization splitting for a second optical signal of a second predetermined wavelength and for coupling both polarizations for the second optical signal in the same direction as the first optical signal of the first predetermined wavelength.

In a further aspect, it is an aim of the present disclosure to provide an integrated optical coupler and a method for coupling light between an optical element such as an optical fiber and at least one integrated optical waveguide by means of such an integrated optical coupler, wherein the optical coupler comprises a one-dimensional or a two-dimensional grating structure and wherein the optical coupler couples light to waveguide modes with different polarization, for example at least one Transverse Electric (TE) waveguide mode and at least one Transverse Magnetic (TM) waveguide mode. Different polarization waveguide modes can correspond to a single wavelength or wavelength band or to substantially different wavelengths or wavelength bands. Coupling of light into a waveguide can be in a single direction (i.e. both forward coupling or both backward coupling) for both modes or in different directions (i.e. at least one backward coupling and at least one forward coupling).

It is an advantage of embodiments of the present disclosure that both a good TE coupling efficiency and a good TM coupling efficiency can be realized. Simultaneous use of TE and TM polarized waveguide modes can lead to better properties, advantageous characteristics, and/or additional functionalities as compared to prior art grating couplers. For example, in embodiments of the present disclosure a one-dimensional grating coupler can be used instead of a prior art two-dimensional grating coupler to perform wavelength duplexing for a randomly polarized light signal. For example, in embodiments of the present disclosure a two-dimensional grating coupler can be used to perform wavelength duplexing with substantially improved Polarization Dependent Loss (PDL) (for example PDL lower than 0.5 dB) as compared to prior art two-dimensional grating couplers.

In another aspect, it is an aim of the present disclosure to provide an integrated optical coupler and a method for coupling light between an optical element such as an optical fiber and an integrated optical waveguide wherein the optical coupler comprises a one-dimensional grating structure and wherein the optical coupler provides polarization splitting for an optical signal of a first predetermined wavelength, thereby maintaining orthogonal polarizations in the integrated optical waveguide and providing a good coupling efficiency for both TE and TM polarizations and a good bandwidth (for example 1 dB bandwidth larger than 50 nm and 3 dB bandwidth larger than 100 nm). Maintaining orthogonal polarizations in the integrated optical waveguide means that simultaneously a TE waveguide mode and a TM waveguide mode of the first predetermined wavelength can be present. The coupling efficiency between the optical element and the integrated optical waveguide can be substantially equal for the TE polarization and the TM polarization, leading to a substantially zero or very low Polarization Dependent Loss (PDL), for example, a PDL lower than 0.5 dB.

In addition to polarization splitting for a first optical signal of a first predetermined wavelength, an integrated optical coupler according to the present disclosure can also provide duplexing and/or polarization splitting of a second optical signal of a second predetermined wavelength substantially different from the first predetermined wavelength, thereby also maintaining orthogonal polarizations (for the second predetermined wavelength) in the integrated optical waveguide.

Alternatively, in addition to polarization splitting of an optical signal of a first predetermined wavelength, an integrated optical coupler according to the present disclosure can also provide coupling of a linearly TE or TM polarized optical signal of a third wavelength and/or of a linearly TE or TM polarized optical signal of a fourth wavelength.

It is an advantage of an integrated optical coupler and a method according to the present disclosure that it provides a better coupling efficiency and a higher bandwidth as compared to prior art integrated polarization splitting optical couplers comprising a two-dimensional grating. It is an advantage of an integrated optical coupler and a method according to the present disclosure that it is less sensitive to the position of the optical element, e.g. optical fiber, with respect to the grating, leading to a higher fabrication tolerance and thus potentially a lower fabrication cost as compared to two-dimensional polarization splitting couplers. For example, the tolerance in fiber position with respect to the grating may be in the 1 to 2 micrometer range. For a one-dimensional grating coupler according to the present disclosure, the difference in coupling efficiency between different polarizations (and thus the PDL) is mainly sensitive to the alignment of the optical element in a direction parallel to the waveguide (i.e., in a direction parallel to a light propagation direction in the waveguide). For prior art two-dimensional grating couplers, misalignment of the optical element in all directions contributes to coupling efficiency differences between different polarizations and thus to the PDL.

In another aspect, it is an aim of the present disclosure to provide an integrated optical coupler and a method for coupling light between an optical element such as an optical fiber and at least one integrated optical waveguide wherein the optical coupler comprises a two-dimensional grating structure, wherein the optical coupler provides polarization splitting for a first optical signal of a first predetermined wavelength and couples both polarizations forward or backward, and wherein the optical coupler provides polarization splitting for a second optical signal of a second predetermined wavelength and couples both polarizations in the same direction as the first optical signal of the first predetermined wavelength. Simultaneously a TE waveguide mode and a TM waveguide mode can be present in the at least one integrated optical waveguide, such as for example a TE waveguide mode for the first predetermined wavelength and a TM waveguide mode for the second predetermined wavelength or vice versa.

It is an advantage of an integrated optical coupler and a method according to the present disclosure that it can provide a better PDL compensation than is possible with prior art two-dimensional grating multiplexers. In prior art two-dimensional grating couplers, the PDL is compensated for or reduced by changing the shape of the diffractive structures of the two-dimensional grating, e.g., by changing the ellipticity of elliptical holes or by changing the length and width of rectangular holes. By optimizing the shape of the two-dimensional grating, the difference in coupling efficiency between different polarizations and thus the PDL is minimized. In prior art grating multiplexers, different wavelengths or wavelength bands are coupled in opposite directions (e.g. a first wavelength is coupled forward and a second wavelength is coupled backward). When two wavelength bands are coupled in opposite directions it is not possible to compensate for the PDL in an equal way for both wavelengths by varying the shape of the diffractive structures of the grating. In embodiments according to this aspect of the present disclosure, two wavelength bands can be coupled in the same direction (e.g. both the first wavelength and the second wavelength are coupled forward or both are coupled backward). This allows a substantially equal PDL compensation for both wavelengths or both wavelength bands.

It is an advantage of an integrated optical coupler and a method according to this aspect of the present disclosure that shorter focusing tapers can be used. The coupling region of prior art grating duplexers can not be made focusing, because one can only make a focusing grating in one direction, i.e. forward or backward. Because according to the present disclosure both wavelength bands are coupled to the same direction, focusing in the coupling region can be implemented, resulting in much shorter focusing tapers, e.g., shorter than 20 micrometer.

It is an advantage of an integrated optical coupler and a method according to the present disclosure that the coupling efficiency between the optical element, e.g. optical fiber, and the integrated optical waveguide can be enhanced, because a larger coupling area can be used, e.g. larger than 10 micrometer, as compared to prior art grating duplexers. In prior art grating duplexers the coupling area between the optical element, e.g. optical fiber, and the grating is limited because there is a need for making a compromise in order to obtain a good coupling efficiency in both directions. According to this aspect of the present disclosure both wavelengths or wavelength bands are coupled in the same direction, thereby avoiding the need for making a compromise and enabling a larger coupling area as compared to the prior art. This leads to an enhanced coupling efficiency for both wavelength bands.

It is an advantage of an integrated optical coupler and a method according to the present disclosure that it is less sensitive to the position of the optical element, e.g. optical fiber, with respect to the grating, leading to a higher fabrication tolerance and thus potentially a lower fabrication cost as compared to prior art two-dimensional grating duplexers. In prior art two-dimensional grating duplexers, the position of the optical element, e.g. optical fiber, is a compromise between obtaining a good coupling efficiency for forward coupling and obtaining a good coupling efficiency for backward coupling at the same time. This leads to a strong dependence of the coupling performance (e.g. PDL, respective coupling efficiencies) on the position of the optical fiber. In embodiments according to the present disclosure both wavelength bands are coupled in the same coupling direction, such that the sensitivity of the coupling performance to the position of the optical fiber is reduced.

In embodiments according to the present disclosure the coupling efficiency between an optical element, e.g. optical fiber, and an integrated optical waveguide can be enhanced by making use of a non-uniform grating. This is not possible in prior art two-dimensional grating duplexers that couple both forward and backward. Non-uniform gratings can enhance the coupling efficiency e.g. by optimizing the overlap of the outcoupled mode to the mode of the optical element, e.g. optical fiber.

In addition to polarization splitting for an optical signal of a first predetermined wavelength and a polarization splitting for a second optical signal of a second predetermined wavelength, an integrated optical coupler according to the present disclosure can also provide triplexing of an optical signal of a third predetermined wavelength substantially different from the first and second predetermined wavelengths. An optical coupler according to this aspect of the present disclosure can also provide quadband coupling of a fourth optical signal of a fourth predetermined wavelength substantially different from the first and second and third predetermined wavelengths. Simultaneously a TE waveguide mode and a TM waveguide mode can be present in the at least one integrated optical waveguide.

The subject matter claimed as inventive is particularly pointed out in the claim section concluding this document. The invention however, both as to organization and method of operation, together with features and advantages thereof, may best be understood by reference to the following detailed description when read with the accompanying drawings.

### BRIEF DESCRIPTION OF THE DRAWINGS

FIG. 1 illustrates the concept of a polarization splitting grating coupler and duplexer according to an embodiment of the present disclosure.

FIG. 2 shows the Bragg diagram for a polarization splitting grating coupler and duplexer according to an embodiment of the present disclosure. The TE polarization of λ₁ is coupled in a first direction. The TM polarization of λ₁ and the TE polarization of λ₂ are coupled in a second direction opposite to the first direction.

FIG. 3 shows coupling spectra of an optimized grating coupler according to an embodiment of the present disclosure for different grating periods.

FIG. 4 shows the theoretical Polarization Dependent Loss of an optimized grating coupler according to an embodiment of the present disclosure for different grating periods.

FIG. 5 is a top view of a measurement set-up used for determining the fiber-to-fiber Polarization Dependent Loss.

FIG. 6 shows experimentally obtained fiber-to-waveguide coupling spectra for an optical coupler according to an embodiment of the present disclosure, illustrating a 5.2 dB maximum coupling efficiency and a −1 dB optical bandwidth of 30 nm (−3 dB optical bandwidth of 50 nm) for 1300 nm (TE polarization) and −5.9 dB maximum coupling efficiency and a −1 dB optical bandwidth of 35 nm (−3 dB optical bandwidth of 65 nm) for 1610 nm (TE polarization).

FIG. 7 shows the experimentally obtained Polarization Dependent Loss by scanning the Poincaré sphere for an optical coupler according to an embodiment of the present disclosure.

FIGS. 8(a) and 8(b) show the simulated coupling efficiency (FIG. 8(a)) and PDL (FIG. 8(b)) for 1310 nm as a function of the fiber position relative to the ‘low PDL’ point for a grating coupler with 9, 12 and 18 grating periods according to an embodiment of the present disclosure.

FIG. 9 schematically illustrates coupling of single wavelength light with a single polarization into an integrated optical waveguide by means of a one-dimensional grating coupler according to the prior art.

FIG. 10(a) schematically illustrates forward coupling and polarization splitting of single wavelength light into integrated optical waveguides by means of a two-dimensional grating coupler according to the prior art.

FIG. 10(b) schematically illustrates backward coupling and polarization splitting of single wavelength light into integrated optical waveguides by means of a two-dimensional grating coupler according to the prior art.

FIG. 11 schematically illustrates coupling of two wavelengths (duplexing) with a single polarization into an integrated optical waveguide by means of a one-dimensional grating coupler according to the prior art.

FIG. 12 schematically illustrates coupling and polarization splitting of two wavelengths into integrated optical waveguides by means of a two-dimensional grating coupler according to the prior art.

FIG. 13 schematically illustrates coupling of four wavelengths with linear polarizations into an integrated optical waveguide by means of a one-dimensional grating coupler according to an embodiment of the present disclosure.

FIG. 14 schematically illustrates coupling and polarization splitting of four wavelengths into integrated optical waveguides by means of a two-dimensional grating coupler according to an embodiment of the present disclosure.

FIG. 15 schematically illustrates coupling of three wavelengths with linear polarizations into an integrated optical waveguide by means of a one-dimensional grating coupler according to an embodiment of the present disclosure.

FIG. 16 schematically illustrates coupling and polarization splitting of three wavelengths into integrated optical waveguides by means of a two-dimensional grating coupler according to an embodiment of the present disclosure.

FIG. 17 schematically illustrates coupling of two wavelengths with linear polarizations and polarization splitting and coupling of a third wavelength into an integrated optical waveguide by means of a one-dimensional grating coupler according to an embodiment of the present disclosure.

FIG. 18 schematically illustrates coupling of two wavelengths (duplexing) with different polarizations into an integrated optical waveguide by means of a one-dimensional grating coupler according to an embodiment of the present disclosure.

FIG. 19 schematically illustrates coupling and polarization splitting of two wavelengths into integrated optical waveguides by means of a two-dimensional grating coupler according to an embodiment of the present disclosure.

FIG. 20 schematically illustrates coupling of two wavelengths (duplexing) with different polarizations into an integrated optical waveguide by means of a one-dimensional grating coupler according to an embodiment of the present disclosure.

FIG. 21 schematically illustrates coupling and polarization splitting of two wavelengths into integrated optical waveguides by means of a two-dimensional grating coupler according to an embodiment of the present disclosure.

FIG. 22 schematically illustrates coupling of a first wavelength with linear TE or TM polarization and coupling and polarization splitting of a second wavelength with random polarization into an integrated optical waveguide by means of a one-dimensional grating coupler according to an embodiment of the present disclosure.

FIG. 23 schematically illustrates coupling and polarization splitting of a single wavelength into an integrated optical waveguide by means of a one-dimensional grating coupler according to an embodiment of the present disclosure.

FIG. 24 schematically illustrates the one-dimensional grating coupler of FIG. 22 integrated with a wavelength demultiplexer element.

FIG. 25 schematically illustrates a coupler for coupling between an optical fiber and an integrated waveguide, according to an embodiment of the present disclosure.

FIGS. 26 and 27 indicate simulation and experimental coupling efficiency as function of wavelength for TE polarization as well as TM polarization for a coupler as shown in FIG. 25.

### DETAILED DESCRIPTION

The present disclosure will describe particular embodiments with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the disclosure described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the disclosure described herein are capable of operation in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps, or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Reference throughout this specification to “one embodiment” or “an embodiment” or “one aspect” or “an aspect” means that a particular feature, structure or characteristic described in connection with the embodiment and/or aspect is included in at least one embodiment and/or aspect of the present invention. Thus, appearances of the phrases “in one embodiment” or “in an embodiment” or “in one aspect” or “in an aspect” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments or aspects.

Similarly it should be appreciated that in the description of exemplary embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments may be practiced without these specific details. In other instances, well-known methods, structures and techniques have not been shown in detail in order not to obscure an understanding of this description.

In the context of the present disclosure, the terms “radiation” and “light” are used for indicating electromagnetic radiation with a wavelength in a suitable range, i.e. electromagnetic radiation with a wavelength that is not absorbed by the materials used (e.g. the waveguide material), for example electromagnetic radiation with a wavelength between 1 μm and 2 μm, e.g. near infrared radiation (NIR) or short wavelength infrared radiation (SWIR).

In the context of the present disclosure, a grating is an optical device comprising a pattern of grooves, channels or cavities or holes. If the pattern is in one direction only, the grating is called a linear or a one-dimensional grating. If the pattern is in two directions, e.g. two orthogonal directions, it is referred to as a two-dimensional grating. The filling factor or duty cycle of a grating is the ratio between the area covered by the part of the grating in between the grooves or holes and the area covered by the grooves or holes. A grating can be periodic (uniform) or non-periodic (non-uniform). In case of a periodic grating the size of the grooves or holes is substantially equal and the distance between the grooves or holes is substantially equal. The period of the grating is then defined as the interval between adjacent grooves or holes. A two-dimensional grating thus has a double periodicity.

The coupling efficiency between an optical element, e.g. optical fiber, and an integrated optical waveguide is defined as the fraction of the light that is coupled from the optical element into the waveguide. By reciprocity, this is also the fraction of light that can be coupled from the waveguide into the optical element.

The Polarization Dependent Loss (PDL) is a measure of the peak-to-peak difference in transmission of an optical component or system with respect to all possible states of polarization. It is the ratio of the maximum and the minimum transmission of an optical device with respect to all polarization states.

Where the term coupling of a wavelength is used, this refers to coupling of an optical signal or light of that wavelength, including a wavelength band around that wavelength.

Where the term high refractive index contrast is used, reference may be made to systems wherein the difference in refractive index, e.g. between a cladding material and a core material, is larger than one refractive index unit. Where reference is made to low refractive index materials, reference may be made to material systems wherein the difference in refractive index, e.g. between a cladding material and a core material, is limited to less than 1, e.g. to one or a few tenths of a refractive index unit.

Forward coupling is used for indicating coupling of light from an optical element, e.g. optical fiber, into an integrated optical waveguide wherein the light in the optical element has a wave vector with a longitudinal component in the same direction as the coupled guided light in the integrated optical waveguide. Backward coupling is used for indicating coupling of light from an optical element, e.g. optical fiber, into an integrated optical waveguide wherein the light in the optical element has a wave vector with a longitudinal component in the opposite direction as the coupled guided light in the integrated optical waveguide.

Transverse electric (TE) polarized light is linearly polarized light with its electric field oriented parallel to the plane of the integrated optical waveguide and normal to its wave vector. Transverse magnetic (TM) polarized light is linearly polarized light with its magnetic field oriented parallel to the plane of the integrated optical waveguide and normal to its wave vector.

Aspects will now be described by a detailed description of several embodiments. It is clear that other embodiments can be configured according to the knowledge of persons skilled in the art without departing from the true spirit or technical teaching of the invention, the invention being limited only by the terms of the appended claims.

It is to be noticed that the present disclosure can be used both for coupling out light or radiation from at least one integrated optical waveguide to a predetermined outcoupling direction, e.g. to an optical coupling element such as an optical fiber, as well as coupling in, e.g. from an optical coupling element such as an optical fiber, a radiation or light beam to at least one integrated optical waveguide.

Certain embodiments of devices and methods of the present disclosure are described in more detail below for a silicon on insulator (SOI) material system. However, the present disclosure is not limited thereto. The methods and devices of the present disclosure can also be used with other material systems, such as for example III-V material systems (e.g. InGaAs/InP, AlGaAs/GaAs) or low index contrast material systems, or with metal gratings.

Certain embodiments of methods and devices of the present disclosure are described in more detail below for coupling of light between an integrated optical waveguide and an optical fiber. However, the disclosure is not limited thereto and can be used for coupling light between an integrated optical waveguide and an optical element such as a light source or a light detector or for coupling light between an integrated optical waveguide and free space or between two optical integrated waveguides (e.g. in a multilayer circuit).

In one aspect the present disclosure relates to an integrated optical coupler for coupling light between an optical element and at least one integrated optical waveguide, wherein the optical coupler comprises a grating structure and wherein the optical coupler is adapted for coupling light to waveguide modes with different polarization with low polarization dependent loss or whereby the coupling to waveguide modes with different polarization is performed with substantially the same coupling efficiency for waveguide modes with different polarization. The disclosure will be described, by way of example, with reference to further aspects and embodiments, different embodiments and/or aspects highlighting different features. As will be clear to the person skilled in the art, several features of different embodiments and/or aspects can be combined with other embodiments and/or aspects.

In one aspect, the present disclosure provides an integrated optical coupler and a method for coupling light between an optical element such as an optical fiber and at least one integrated optical waveguide by means of such an integrated optical coupler, wherein the optical coupler comprises a one-dimensional or a two-dimensional grating structure and wherein the optical coupler couples light to waveguide modes with different polarization, for example at least one Transverse Electric (TE) waveguide mode and at least one Transverse Magnetic (TM) waveguide mode. Different polarization waveguide modes can correspond to a single wavelength or wavelength band or to substantially different wavelengths or wavelength bands. Coupling of light into a waveguide can be in a single direction (i.e. both forward coupling or both backward coupling) for both modes or in different directions (i.e. at least one backward coupling and at least one forward coupling).

In one aspect, the present disclosure provides an integrated optical coupler and a method for coupling light between an optical element such as an optical fiber and an integrated optical waveguide wherein the optical coupler comprises a one-dimensional grating structure and wherein the optical coupler provides polarization splitting for an optical signal of a first predetermined wavelength, thereby maintaining orthogonal polarizations in the integrated optical waveguide and providing a good coupling efficiency for both TE and TM polarizations and a good bandwidth (for example 1 dB bandwidth larger than 50 nm and 3 dB bandwidth larger than 100 nm). Maintaining orthogonal polarizations in the integrated optical waveguide means that simultaneously a TE waveguide mode and a TM waveguide mode can be present. The coupling efficiency between the optical element and the integrated optical waveguide can be substantially equal for the TE polarization and the TM polarization, leading to a substantially zero or very low Polarization Dependent Loss (PDL), for example a PDL lower than 0.5 dB.

In addition to polarization splitting for a first optical signal of a first predetermined wavelength, an integrated optical coupler according to this aspect of the present disclosure can also provide duplexing and/or polarization splitting of a second optical signal of a second predetermined wavelength substantially different from the first predetermined wavelength, thereby also maintaining orthogonal polarizations in the integrated optical waveguide.

Alternatively, in addition to polarization splitting of an optical signal of a first predetermined wavelength, an integrated optical coupler according to this aspect of the present disclosure can also provide coupling of a linearly TE or TM polarized optical signal of a third wavelength and/or of a linearly TE or TM polarized optical signal of a fourth wavelength.

In one aspect, the present disclosure provides an integrated optical coupler and a method for coupling light between an optical element such as an optical fiber and an integrated optical waveguide wherein the optical coupler comprises a two-dimensional grating structure, wherein the optical coupler provides polarization splitting for a first optical signal of a first predetermined wavelength and couples both polarizations forward or backward, and wherein the optical coupler provides polarization splitting for a second optical signal of a second predetermined wavelength and couples both polarizations in the same direction as the first optical signal of the first predetermined wavelength. Simultaneously a TE waveguide mode and a TM waveguide mode can be present in the at least one integrated optical waveguide, such as for example a TE waveguide mode for the first predetermined wavelength and a TM waveguide mode for the second predetermined wavelength or vice versa.

In embodiments according to the present disclosure the coupling efficiency between an optical element, e.g. optical fiber, and an integrated optical waveguide can be enhanced by making use of a non-uniform grating. This is not possible in prior art two-dimensional grating duplexers that couple both forward and backward. Non-uniform gratings can enhance the coupling efficiency e.g. by optimizing the overlap of the outcoupled mode to the mode of the optical element, e.g. optical fiber.

In addition to polarization splitting for a first optical signal of a first predetermined wavelength and a polarization splitting for a second optical signal of a second predetermined wavelength, an integrated optical coupler according to one aspect of the present disclosure can also provide triplexing of a optical signal of a third predetermined wavelength substantially different from the first and second predetermined wavelength. An optical coupler according to one aspect of the present disclosure can also provide quadband coupling of a fourth optical signal of a fourth predetermined wavelength substantially different from the first and second and third predetermined wavelength. Simultaneously a TE waveguide mode and a TM waveguide mode can be present in the at least one integrated optical waveguide.

An optical coupler according to embodiments of the present disclosure comprises a one-dimensional or two-dimensional diffraction grating structure in or onto an integrated optical waveguide formed on a substrate. An optical element such as an optical fiber may be coupled to the grating structure. The grating parameters (such as e.g. thickness of the waveguide layers, groove depth or etch depth, filling factor or duty cycle, grating period, number of periods) as well as the position of the optical fiber relative to the grating and the angle of the optical fiber with respect to the orthogonal to the plane of the integrated optical waveguide are adapted for realizing a predetermined functionality of the grating coupler for at least one optical signal of a predetermined wavelength. For example, the grating parameters can be adapted for coupling randomly polarized light to waveguide modes with different polarization for at least one optical signal. For example, the grating parameters can be adapted for coupling light into a waveguide in a single direction for different polarization modes or for coupling light into a waveguide in different directions for different polarization modes. For example, the grating parameters can be adapted for realizing a good coupling efficiency for different polarizations and/or different wavelengths. For example, the grating parameters can be adapted for providing a duplexing, a triplexing or a quaduplexing operation. In preferred embodiments of the present disclosure the grating parameters and the fiber position and fiber angle are adapted for minimizing the Polarization Dependent Loss.

In the following description, examples are given for grating couplers comprising rectangular grooves or holes with straight side walls. However, other suitable groove or hole shapes known to a person skilled in the art can be used, such as for example grooves with sloped walls or stair case grooves. In addition, the shape of the holes and the period of the grating can be non-uniform and vary along the grating.

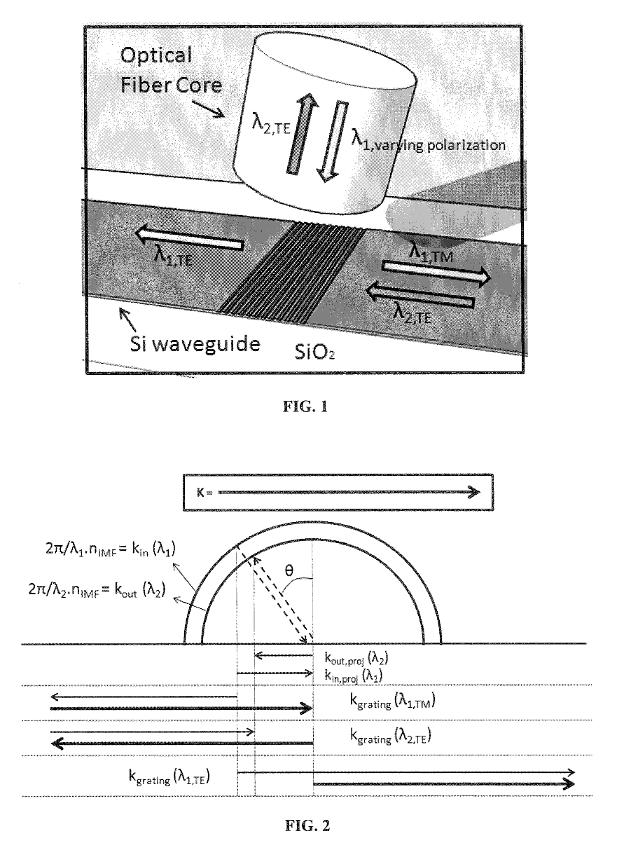

FIG. 1 shows a polarization splitting grating coupler according to an embodiment of one aspect of the present disclosure. In the example shown, the grating coupler comprises a one-dimensional grating structure provided in the core layer of a Silicon-On-Insulator (SOI) waveguide. An optical fiber is coupled to the grating structure. Light of a random polarization of a first wavelength λ₁ can be coupled from the optical fiber into the SOI waveguide, thereby splitting the light into a TE polarized signal that is coupled in a first direction in the optical waveguide (also referred to as forward coupling) and a TM polarized signal that is coupled in the opposite direction in the optical waveguide (also referred to as backward coupling). In the example shown, an optical signal of a different wavelength λ₂ and having a TE polarization is coupled at the same time from the waveguide into the same optical fiber thus providing a duplexer operation.

The polarization splitting grating coupler of the present disclosure can also be used in the reverse way, wherein a TE polarized signal of wavelength λ₁ from a first direction in the integrated optical waveguide is coupled to an optical fiber by the one-dimensional diffraction grating and wherein a TM polarized signal of wavelength λ₁ from a second, opposite, direction in the integrated optical waveguide is coupled to the same optical fiber by the one-dimensional diffraction grating. In addition an optical signal of a different wavelength λ₂ and having a TE polarization can be coupled at the same time from the waveguide into the fiber thus providing a duplexer operation.

One can analyze the effect of a one-dimensional diffraction grating by using the projected Bragg condition (FIG. 2):

k_{grating}(λ,TE/TM)=k_{in,prof}(λ)±mK (1)

wherein k_{grating} is the effective wave vector of the grating, K is the reciprocal is lattice vector of the grating (i.e. 2π divided by the grating period), k_{grating} is the projected wave vector of the incident light and the integer m is the diffraction order. For low index contrast platforms, k_{grating} can be approximated by the effective wave vector of the waveguide. Dealing with high index contrast platforms is done by estimating the effective refractive index of the grating based on the mean refractive index of the grating. This is a powerful tool that can be used for a first order design of a fiber coupler grating instead of rigorous numerical simulation techniques. The effective wave vector of the grating, k_{grating}, not only depends on the wavelength, but also on the polarization state. Because the wavelength variable in (1) is continuous and taking into account the two polarization states and the fact that light can be coupled forward (in a first direction) or backward (in a second direction opposite to the first direction) into the waveguide, it is in theory possible to fulfill the first order Bragg condition for four wavelengths simultaneously. This can be used for example to broaden the bandwidth of a grating coupler, in the form of a grating duplexer that couples two separate wavelength bands in opposite directions.

A one-dimensional grating coupler as illustrated in FIG. 1 according to an embodiment of the present disclosure was designed and fabricated, wherein the coupler couples both orthogonal polarizations (TE and TM) of a random polarized signal with first predetermined wavelength λ1 and a TE polarized signal with a second predetermined wavelength λ₂ (the second predetermined wavelength being substantially different from the first predetermined wavelength) into a single optical waveguide, the TE polarized mode of the first predetermined wavelength being coupled in a first direction in the optical waveguide and both the TM polarized mode of the first predetermined wavelength and the TE polarized mode of the second predetermined wavelength being coupled into a second direction in the optical waveguide, the second direction being opposite to the first direction. This is illustrated in FIG. 1. The corresponding Bragg diagram of such a grating coupler is shown in FIG. 2.

In one example, embodiments of the present disclosure not being limited by theoretical considerations, a polarization splitting grating coupler for coupling a TE polarization of and a TM polarization can be designed taking into account the Bragg conditions. For example in a polarization splitting grating coupler for coupling a TE polarization for a wavelength in one direction and a TM polarization of the same wavelength radiation in a backward direction can be designed taking into account the following system of Bragg conditions

$$\frac{2 π}{{λ}_{1}} {n}_{eff} ( {λ}_{1} ) = \frac{2 π}{{λ}_{1}} {n}_{clad} sin θ + \frac{2 π}{Λ} ( TE ) \\ - \frac{2 π}{{λ}_{1}} {n}_{eff} ( {λ}_{1} ) = \frac{2 π}{{λ}_{1}} {n}_{clad} sin θ - \frac{2 π}{Λ} ( TM )$$

If a further wavelength radiation is to be taken into account, the corresponding Bragg condition is also taken into account. The Bragg conditions expressing the different radiation splitting typically may be solved by varying the grating period Λ, the fiber angle θ, and the effective refractive index n_{eff} of the grating, which depends on the wavelength, etch depth, waveguide thickness, duty cycle of the grating, and optionally the thickness of a silicon overlay. Varying the waveguide thickness may advantageously not be selected as it, besides influencing the effective refractive index, also influences all other optical components in the integrated circuit. The etch depth may be fixed in order to have an optimal grating coupling strength and a silicon overlay thickness may be fixed to have high directionality towards the optical fiber.

In one example, the design of the one-dimensional grating coupler was based on a Silicon-on-Insulator (SOI) platform with a thickness of the silicon waveguide core of 220 nm and a buried oxide layer (cladding layer) with a thickness of 2 μm on a silicon substrate. The etch depth of the grating, i.e. the depth of the (rectangular) grooves, is assumed to be 70 nm. It is also assumed that an Index Matching Fluid (IMF) is applied on top of the grating. The grating period, duty cycle and the number of periods were adapted using an optimization algorithm, in order to achieve maximum coupling efficiency between the optical fiber and the optical waveguide for a first wavelength λ₁=1310 nm, both for TE polarization and TM polarization, and for TE polarized light of a second wavelength λ₂≈1625 nm. This second wavelength can not be chosen freely because of the fixed parameters that were selected for the grating in this example. By varying the silicon waveguide thickness, i.e. the thickness of the silicon core layer, and/or etch depth of the grating and/or by making use of a silicon overlay, the second wavelength λ₂ can be different, such as for example 1550 nm or 1490 nm, which are wavelengths that are particularly interesting for integrated transceivers for Fiber-to-the-Home optical access networks.

In general, the coupling spectra (i.e. the coupling efficiencies as a function of the wavelength) of the two orthogonal polarizations for a predetermined wavelength are different. This causes polarization dependent loss (PDL). It is thus preferred to minimize this difference between the coupling efficiency of the TE polarization and the TM polarization. The wavelength where the coupling spectrum of the TE polarization crosses the coupling spectrum of the TM-polarization, i.e. where the coupling efficiency of the TE polarization is substantially equal to the coupling efficiency of the TM polarization, corresponds to zero PDL.

By varying the position of the optical fiber with respect to the grating and by varying the angle formed by the optical fiber with respect to the surface normal to the integrated optical waveguide, it is possible to obtain coupling spectra with a maximum at the same wavelength for both polarizations and thus to set the ‘zero PDL’ wavelength equal to the wavelength that corresponds to the maximum of the coupling spectra. This is the ‘low PDL’ point/angle of the optical fiber for a particular grating.

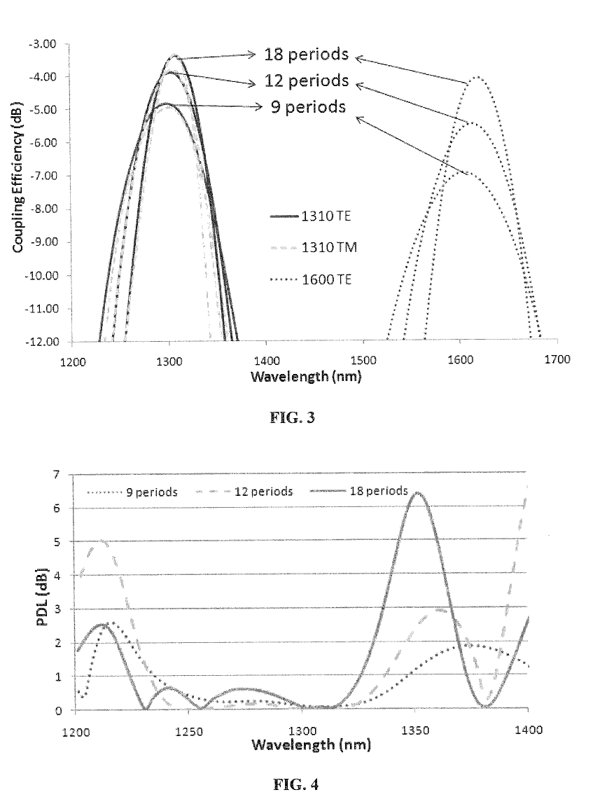

FDTD simulation results of a grating where the fiber angle and position are optimized for a low PDL over a broad wavelength range are shown in FIG. 3 and FIG. 4 for different numbers of grating periods (9, 12 and 18 periods). The period of the grating is 536 nm and the grating duty cycle is 48%. The optical fiber is assumed to be tilted under an angle (the ‘low PDL’ angle) of 14.9°. FIG. 3 shows the coupling spectra for 1310 nm TE polarized light, for 1310 nm TM polarized light and for 1600 nm TE polarized light, for different grating periods. The theoretical coupling efficiencies are −3.4 dB for 1310 nm and −4.1 dB for 1625 nm for the case of 18 grating periods. The fiber-to-fiber PDL (shown in FIG. 4), mainly caused by the difference in bandwidth between the coupling spectra of the TE and TM-polarization, is lower than 0.6 dB over a wavelength range of 100 nm (for the example with 18 grating periods).

Fabrication of the diffractive grating structure was performed on a 200 mm SOI wafer, comprising a 220 nm thick silicon waveguide core layer and a 2 μm thick buried oxide cladding layer on a silicon substrate. Standard CMOS technology was used for the fabrication. The PDL minimization method according to the present disclosure was used, leading to a ‘low PDL’ fiber angle of 14° with respect to the orthogonal to the waveguide plane.

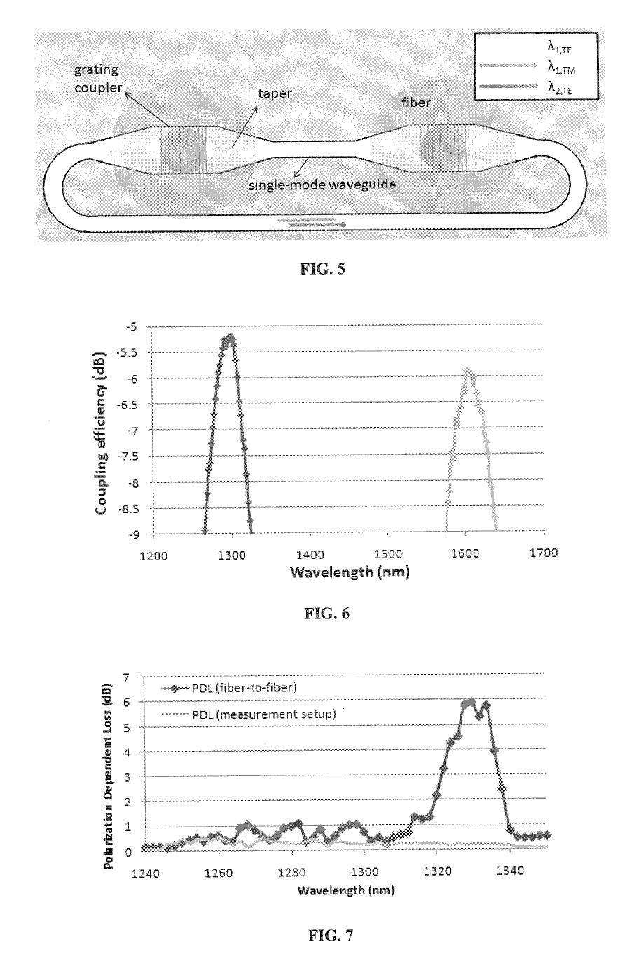

FIG. 5 schematically illustrates the measurement set-up that was used for measuring a fiber-to-fiber coupling efficiency. From these measurements the fiber-to-waveguide coupling efficiency was calculated. Measured transmission spectra, shown in FIG. 6, for the optimized grating with eighteen periods show −5.2 dB coupling efficiency for 1300 nm (mean coupling efficiency for both polarizations) with a −1 dB optical bandwidth of 30 nm and −5.9 dB for 1610 nm TE with a −1 dB optical bandwidth of 35 nm. Index matching fluid was applied between the optical fiber facet and the fiber coupler to avoid reflections at the fiber facets. With a polarization scanning technique, the PDL was measured as a function of the wavelength. From the results shown in FIG. 7 it can be concluded that in the wavelength range from 1240 nm until 1312 nm the PDL is lower than 1 dB (this covers 42 nm within the −3 dB optical bandwidth (50 nm) of the coupler). FIG. 7 also shows the PDL of the measurement setup, reaching 0.5 dB for certain wavelengths.

It is an advantage of an integrated optical coupler and a method according to one aspect of the present disclosure (e.g. as illustrated in FIG. 1) that it provides a better coupling efficiency and a higher bandwidth as compared to prior art integrated polarization splitting optical couplers comprising a two-dimensional grating. It is an advantage of an integrated optical coupler and a method of according to one aspect of the present disclosure that it is less sensitive to the position of the optical element, e.g. optical fiber, with respect to the grating, leading to a higher fabrication tolerance and thus potentially a lower fabrication cost as compared to two-dimensional polarization splitting couplers. For example, the tolerance in fiber position with respect to the grating may be in the 1 to 2 micrometer range. For a one-dimensional grating coupler according to one aspect of the present disclosure, the difference in coupling efficiency between different polarizations (and thus the PDL) is mainly sensitive to the alignment of the optical element in a direction parallel to the waveguide (i.e. in a direction parallel to a light propagation direction in the waveguide). For prior art two-dimensional grating couplers, misalignment of the optical element in all directions contributes to coupling efficiency differences between different polarizations and thus to the PDL.

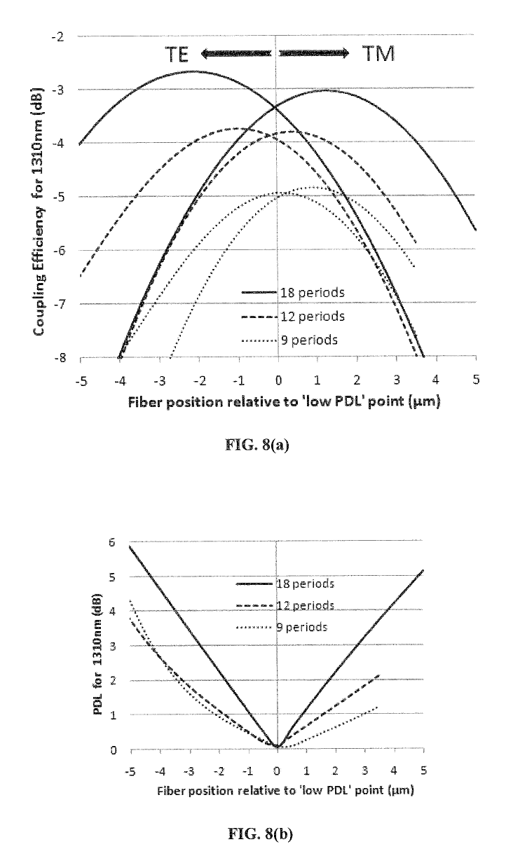

A low alignment sensitivity of the optical fiber with respect to the grating coupler, in view of the coupling efficiency, is a very important property of fiber couplers and is of the order of 2 μm for prior art two-dimensional couplers. An analysis was performed on how the PDL of a grating coupler according to one aspect of the present disclosure is affected by the position of the optical fiber. It is clear that movement of the fiber in a direction parallel to the grating lines or grooves has little effect on the PDL. Movement parallel to the waveguide direction, i.e. substantially orthogonal to the grating lines, on the other hand may influence the PDL strongly. This is easily understood by the fact that, as illustrated in FIG. 8(a), the ‘low PDL’ position of the optical fiber and the optimal coupling positions for a given polarization do not coincide. If the fiber is moved from this optimal low PDL position (indicated with 0 in FIG. 8(a)), it moves towards the optimal coupling position for a certain polarization and away from the optimal coupling position for the other polarization. Assuming in first order a linearly dependent coupling efficiency as a function of fiber position, the 1 dB alignment sensitivity of the PDL is half the alignment sensitivity of the coupling efficiency and thus in the example shown approximately 1 micrometer. The 1 dB PDL alignment sensitivity is the distance for which the PDL increases by 1 dB if the fiber is misaligned in a certain direction. As shown in FIG. 8(b), where the PDL is plotted versus the misalignment of the fiber with respect to the low PDL position, a 1 micron 1 dB PDL alignment sensitivity is obtained for a grating coupler with 18 periods. In combination with FIG. 3 it can also be seen that if the number of grating periods is reduced to 12, the coupling efficiency drops approximately by 1 dB, but the 1 dB PDL alignment sensitivity doubles. If the number of grating periods is further reduced the coupling efficiency further drops by about 1 dB and the 1 dB PDL alignment sensitivity becomes −2/+3 micrometer. The optimal grating length (i.e. the number of periods times the grating period) depends strongly on the particular application and is determined by the required efficiency and robustness specifications.

An optical coupler according to embodiments of the present disclosure couples light to different waveguide modes, for example a TE waveguide mode and a TM waveguide mode. Different polarization waveguide modes can correspond to a single wavelength or wavelength band or to substantially different wavelengths or wavelength bands. Coupling of light into a waveguide can be in a single direction (I.e. both forward coupling or both backward coupling) for both modes or in different directions.

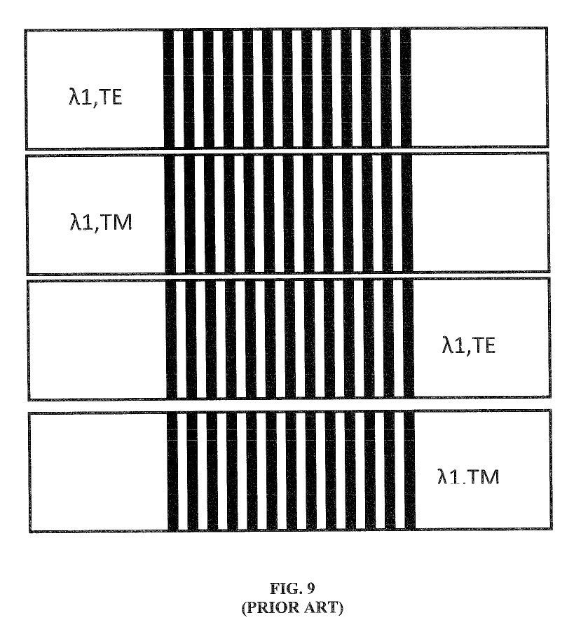

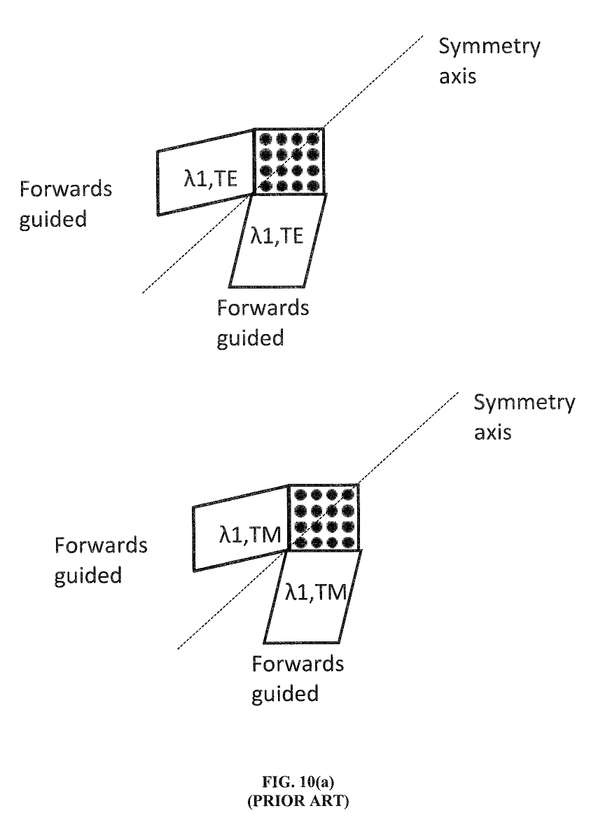

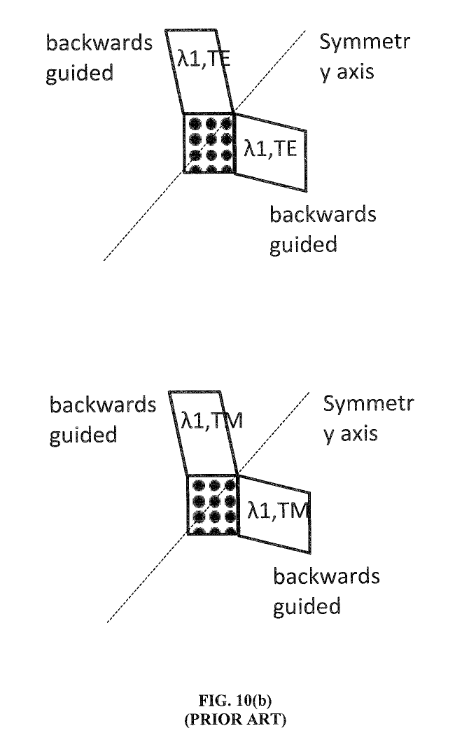

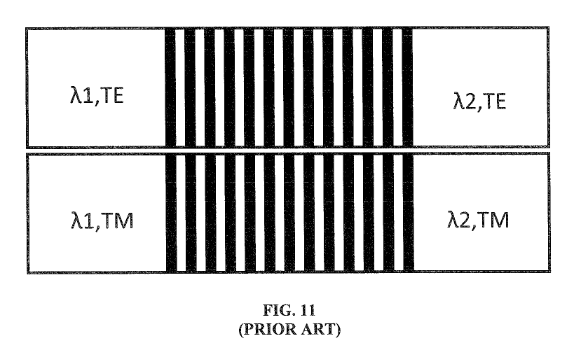

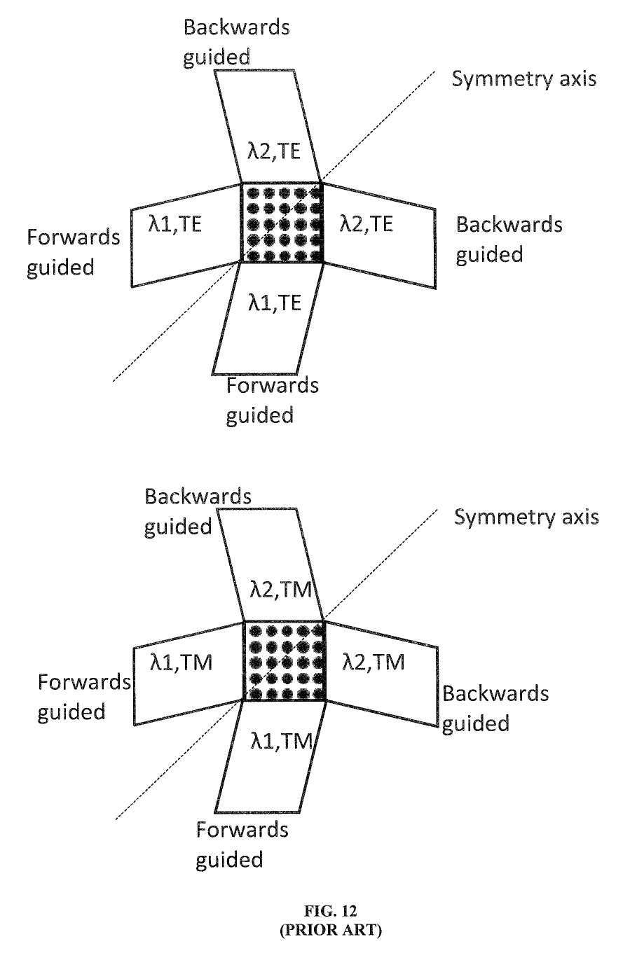

This is clearly different from prior art optical grating couplers, wherein coupling of light into an integrated optical waveguide results in a single polarization mode (either TE or TM) in the waveguide. For example, FIG. 9 schematically illustrates coupling of single wavelength light with a TE or TM polarization into an integrated optical waveguide by means of a one-dimensional grating coupler according to the prior art. The light can be coupled forward or backward and the polarization is maintained in the waveguide. FIG. 10(a) schematically illustrates forward coupling and polarization splitting, and FIG. 10(b) schematically illustrates backward coupling and polarization splitting of single wavelength light into integrated optical waveguides by means of a two-dimensional grating coupler according to the prior art. In case of randomly polarized light, a polarization splitting occurs into two waveguides, leading to a single polarization mode in both waveguides (either TE or TM). FIG. 11 schematically illustrates coupling of two wavelengths (duplexing) with a TE or TM polarization into an integrated optical waveguide by means of a one-dimensional grating coupler according to the prior art. A first wavelength is coupled forward and a second wavelength is coupled backward. The polarization is the same for both wavelengths. FIG. 12 schematically illustrates coupling and polarization splitting of two wavelengths (duplexing) into integrated optical waveguides by means of a two-dimensional grating coupler according to the prior art. Also in this case a first wavelength is coupled forward and a second wavelength is coupled backward. Polarization splitting leads to a single polarization in all waveguides (either TE or TM).

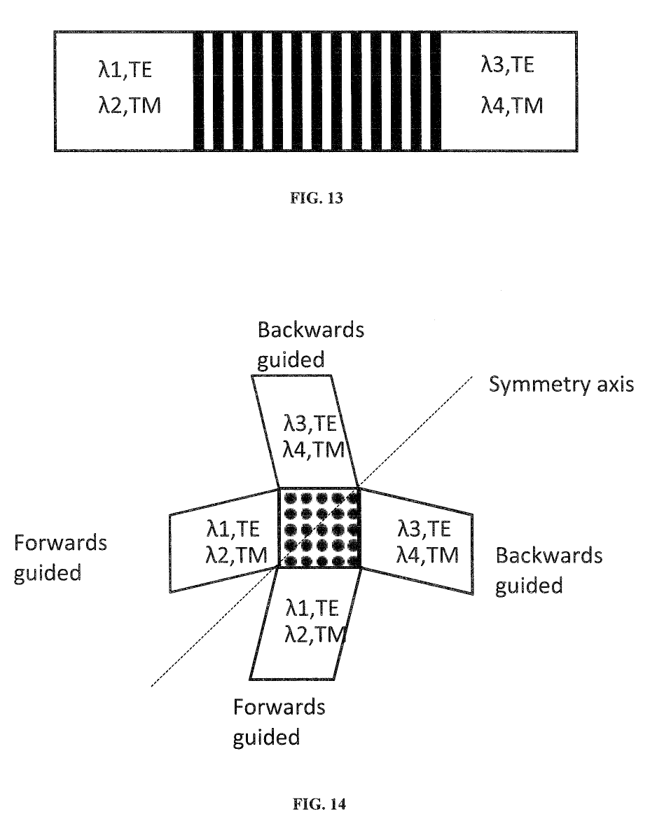

Examples of embodiments of the present disclosure are illustrated in FIGS. 13 to 24.

FIG. 13 schematically illustrates coupling of four wavelengths or wavelength bands with TE or TM polarizations into an integrated optical waveguide by means of a one-dimensional grating coupler according to an embodiment of the present disclosure (polarization dependent quad-band coupling). In the example shown a first wavelength λ₁ with TE polarization and a second wavelength λ₂ with TM polarization are coupled forward. At the same time a third wavelength λ₃ with TE polarization and a fourth wavelength λ₄ with TM polarization are coupled backward. This embodiment enables the use of a one-dimensional grating coupler to perform a quad-band coupling function. Using a one-dimensional grating coupler, it provides a better coupling efficiency and a higher bandwidth as compared to integrated polarization splitting optical couplers comprising a two-dimensional grating.

FIG. 14 schematically illustrates coupling and polarization splitting of four wavelengths into integrated optical waveguides by means of a two-dimensional grating coupler according to an embodiment of the third aspect of the present disclosure (quad band coupling and polarization splitting). In the example shown a first wavelength λ₁ with random polarization and a second wavelength λ₂ with random polarization are coupled forward. For both wavelengths a polarization splitting is performed. This leads to a TE mode for λ₁ in a first waveguide and a second waveguide and a TM mode for λ₂ in the first waveguide and the second waveguide. A third wavelength λ₃ with random polarization and a fourth wavelength λ₄ with random polarization are coupled backward and for both wavelengths a polarization splitting is performed. This leads to a TE mode for λ₃ in a third waveguide and a fourth waveguide and a TM mode for λ₄ in the third waveguide and the fourth waveguide.

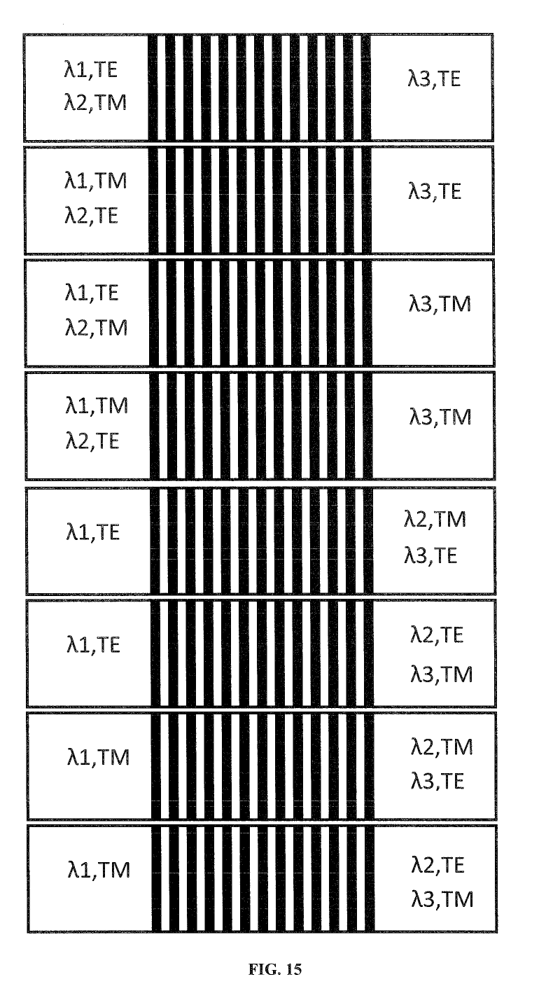

FIG. 15 schematically illustrates coupling of three wavelengths with linear polarizations into an integrated optical waveguide by means of a one-dimensional grating coupler according to an embodiment of one aspect of the present disclosure (polarization dependent triple-band coupling). A plurality of different variations are shown, wherein a TM mode for one wavelength and a TE mode for another wavelength are present in a single waveguide. This embodiment enables the use of a one-dimensional grating coupler to perform a triplex function.

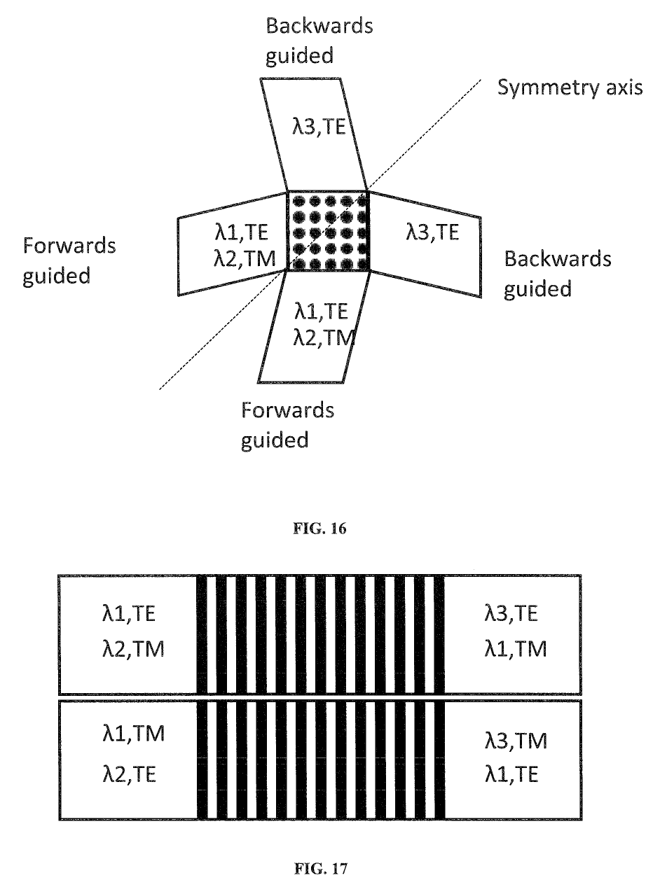

FIG. 16 schematically illustrates coupling and polarization splitting of three wavelengths into integrated optical waveguides by means of a two-dimensional grating coupler according to an embodiment of the third aspect of the present disclosure (triple band coupling and polarization splitting). Also in this embodiment, TE and TM modes are present in a single waveguide.

FIG. 17 schematically illustrates polarization splitting and coupling of a first wavelength with random polarization and coupling of a second and third wavelength with known TE or TM polarization into an integrated optical waveguide by means of a one-dimensional grating coupler according to an embodiment of one aspect of the present disclosure (triple band coupling with polarization splitting for one wavelength). In the first example shown, a first wavelength λ₁ with random polarization is split into a forward coupled TE mode and a backward coupled TM mode. At the same time a TM polarized signal with wavelength λ₂ is coupled forward and a TE polarized signal with wavelength λ₃ is coupled backward. The wavelengths λ₂ and λ₃ can be different or they can be the same. If λ₂ equals λ₃, the example shown in FIG. 17 illustrates dual band coupling with polarization splitting for both wavelength bands. This embodiment allows coupling in or out of two wavelength bands with random polarization, for example for amplifying or splitting a signal in a fiber between a central office and a receiver.

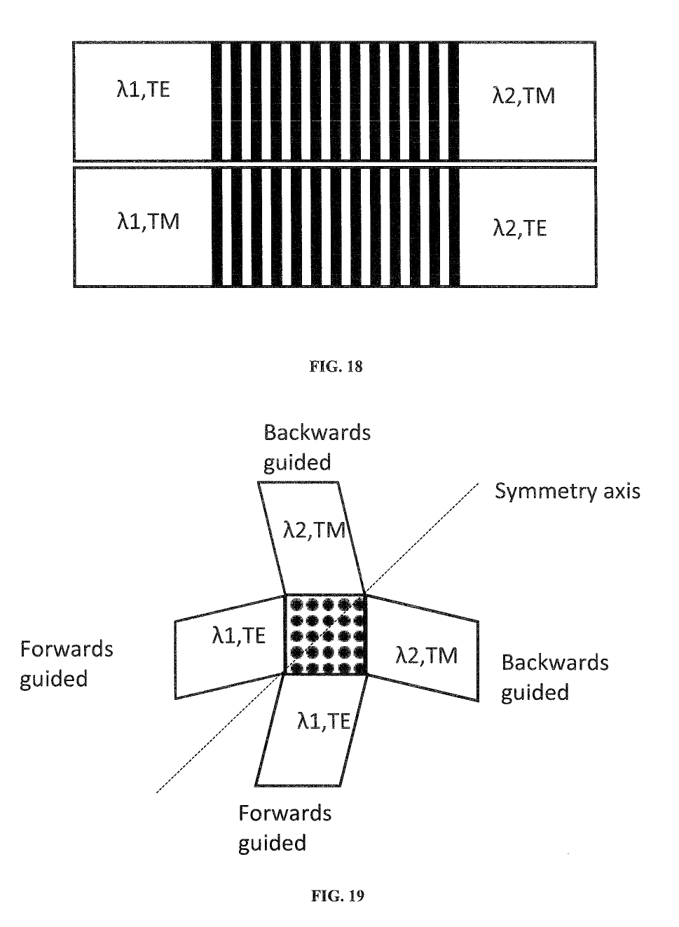

FIG. 18 schematically illustrates coupling of two wavelengths (duplexing) with different polarizations into an integrated optical waveguide by means of a one-dimensional grating coupler according to an embodiment of one aspect of the present disclosure. A first wavelength or wavelength band is coupled forward, while a second wavelength or wavelength band is coupled backward. Both wavelengths have a different polarization.

FIG. 19 schematically illustrates coupling and polarization splitting of two wavelengths into integrated optical waveguides by means of a two-dimensional grating coupler according to an embodiment of the present disclosure. A first wavelength or wavelength band is coupled into the waveguides as a TE mode while a second wavelength or wavelength band is coupled as a TM mode.

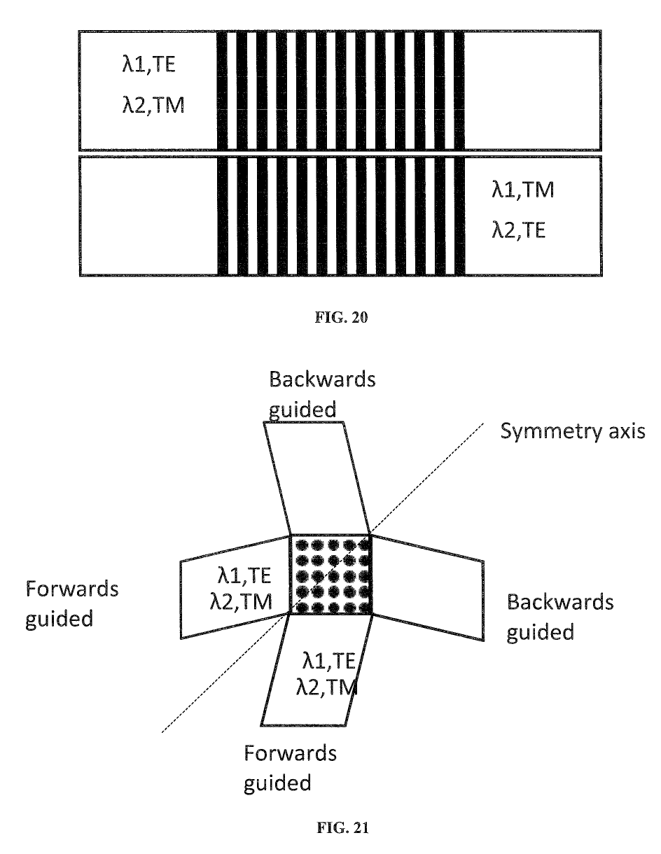

FIGS. 20 and 21 show embodiments coupling light from an optical element in guided waves propagating in the same direction, e.g. coupling light from an optical element in forward guided waves or coupling light from an optical element in backward guided waves.

FIG. 20 schematically illustrates coupling of two wavelengths with different polarizations into an integrated optical waveguide by means of a one-dimensional grating coupler according to an embodiment of the present disclosure. Both wavelengths have a different polarization and both are coupled into the same direction (i.e. either both forward or both backward).

FIG. 21 schematically illustrates coupling and polarization splitting of two wavelengths into integrated optical waveguides by means of a two-dimensional grating coupler according to an embodiment of the present disclosure. Both wavelengths have a different polarization in the waveguides and both are coupled into the same direction (i.e. either both forward or both backward).

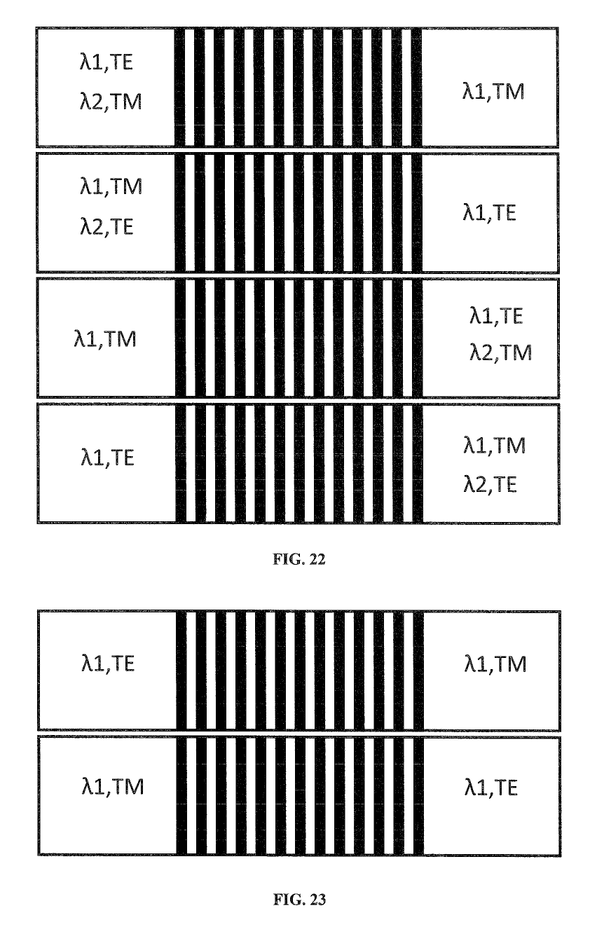

FIG. 22 schematically illustrates coupling of a first wavelength with single polarization and coupling and polarization splitting of a second wavelength into an integrated optical waveguide by means of a one-dimensional grating coupler according to an embodiment of the present disclosure.

FIG. 23 schematically illustrates coupling and polarization splitting of a single wavelength into an integrated optical waveguide by means of a one-dimensional grating coupler according to an embodiment of the present disclosure. The polarization mode of the forward coupled signal is different from the polarization mode of the backward coupled signal.

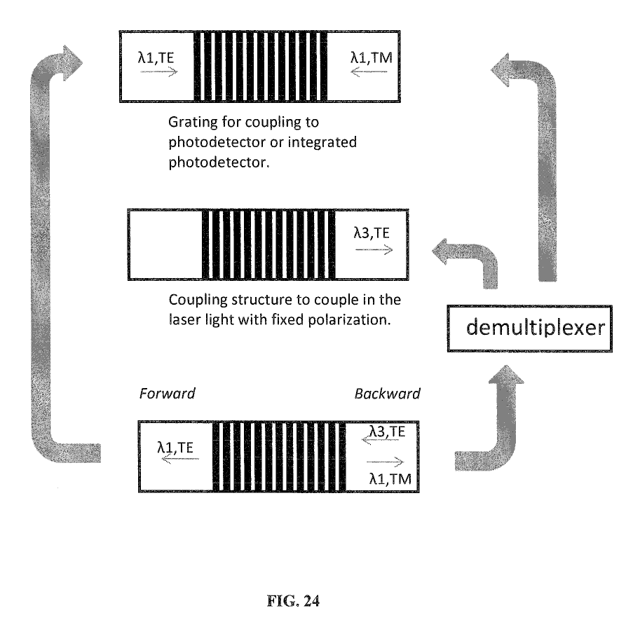

It is a feature of the present disclosure that different wavelengths may be coupled to a single waveguide. In many practical applications there is a need for demultiplexing these wavelengths. Integrated photonics allow integrating a wavelength demultiplexer in the path of the guided mode to separate the different wavelengths. FIG. 24 schematically illustrates the one-dimensional grating coupler of FIG. 22, integrated with a wavelength demultiplexer element (e.g. directional coupler, multimode interferometer, planar concave grating demultiplexer, ring resonator, or other demultiplexer) to separate the different wavelengths or wavelength bands. A similar configuration can be used for two-dimensional duplexers, triplexers or quad band multiplexers.

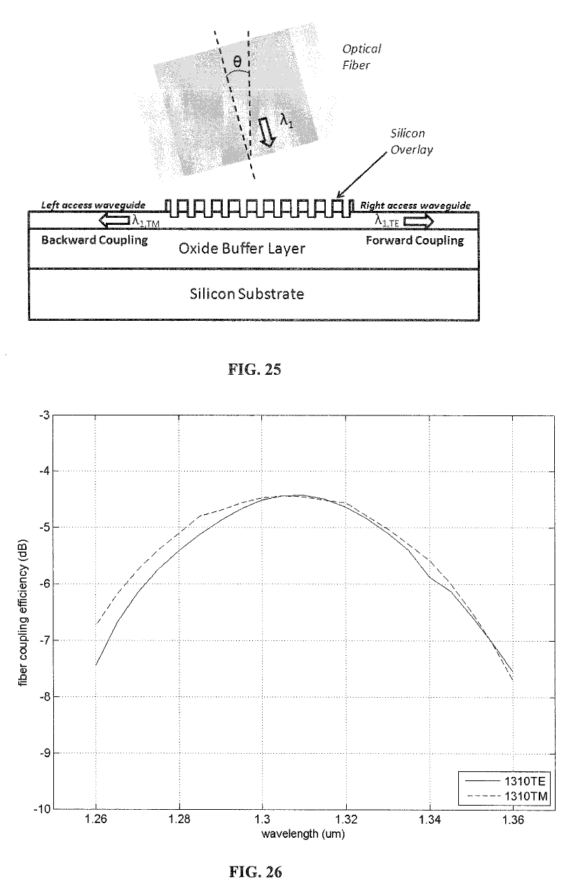

By way of illustration, some examples of couplers are provided illustrating features and advantages of embodiments of the present disclosure. In one particular set of examples, the coupler and structure are designed for a wavelength of 1550 nm whereby a silicon overlay is used in the coupler. Two examples of structures are discussed, both having a structure as shown in FIG. 25. In one example, an oxide cladding is used and the grating has a period of 0.705 and a duty cycle of 50%. The fiber is tilted over a fiber angle of 19°. In a second example, an air cladding is used and the grating has a period of 0.740 and a duty cycle of 50%. The fiber is tilted over a fiber angle of 32.5°. The expected coupling efficiency is −2.5 dB for both polarizations.

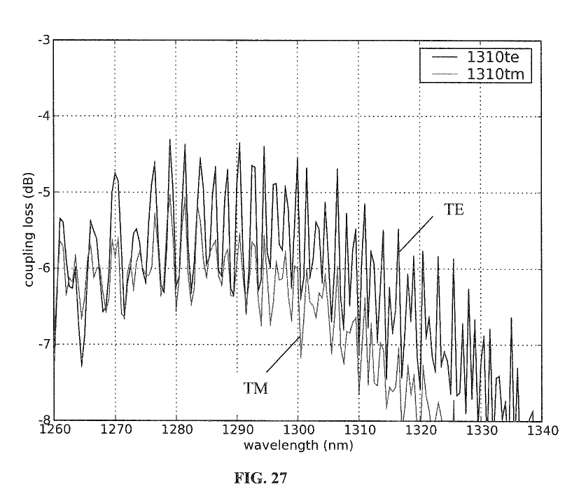

In a second particular set of examples, the coupler and structure are designed for a relatively broad wavelength band. The structure is a one dimensional TE/TM fiber coupler designed to have a reasonable peak efficiency combined with a good efficiency at the edge of a 100 nm wide band. The structure, shown in FIG. 25, is defined for a wavelength of 1310 nm, an overlay thickness of 160 nm, an etch depth for the structures of 235 nm, a grating period of 510 nm, a duty cycle of 0.44, a fiber tilt angle of 11.5 degrees, a number of periods being 8 and an oxide top cladding being present. FIG. 26 and FIG. 27 illustrate simulation respectively experimental results for coupling using the structure of FIG. 25. More particularly, the fiber coupling efficiency or fiber coupling loss is shown as function of wavelength, for both the TE mode as the TM mode. It can be seen that only small differences in coupling efficiency or coupling loss are present between the two modes, the example thus showing features and advantages of embodiments of the present disclosure.

1. An integrated optical coupler for coupling light between an optical element and at least one integrated optical waveguide, wherein the optical coupler comprises a grating structure and wherein the optical coupler is adapted to couple light to waveguide modes with different polarization with low polarization dependent loss.

2. The integrated optical coupler according to claim 1, wherein the optical coupler is adapted to couple light to waveguide modes with different polarization with a polarization dependent loss smaller than 0.5 dB.

3. The integrated optical coupler according to claim 1, wherein the optical coupler is adapted to couple light to at least one Transverse Electric (TE) waveguide mode and at least one Transverse Magnetic (TM) waveguide mode.

4. The integrated optical coupler according to claim 1, wherein the optical coupler is adapted to couple light in a single direction into the waveguide.

5. The integrated optical coupler according to claim 1, wherein the optical coupler is adapted to couple different waveguide modes in different directions.

6. The integrated optical coupler according to claim 1, wherein the optical coupler comprises a one-dimensional grating structure and wherein the optical coupler is adapted to provide polarization splitting for an optical signal of a first predetermined wavelength and maintain orthogonal polarizations in the integrated optical waveguide.

7. The integrated optical coupler according to claim 6, wherein the coupler is adapted to provide a good coupling efficiency for both TE and TM polarizations and a 1 dB bandwidth larger than 50 nm.

8. The integrated optical coupler according to claim 6, the optical coupler being further adapted to provide multiplexing and/or polarization splitting of a second optical signal of a second predetermined wavelength substantially different from the first predetermined wavelength, thereby maintaining orthogonal polarizations for the second predetermined wavelength in the integrated optical waveguide.

9. The integrated optical coupler according to claim 6, wherein in addition to polarization splitting of an optical signal of a first predetermined wavelength, the coupler also is adapted to couple a linearly TE or TM polarized optical signal of a third wavelength and/or a linearly TE or TM polarized optical signal of a fourth wavelength.

10. The integrated optical coupler according to claim 1, wherein the optical coupler comprises a two-dimensional grating structure, and wherein the optical coupler is adapted to provide polarization splitting for a first optical signal of a first predetermined wavelength and to couple both polarizations forward or backward.

11. The integrated optical coupler according to claim 10, wherein the optical coupler is further adapted to provide polarization splitting for a second optical signal of a second predetermined wavelength and to couple both polarizations for the second optical signal in the same direction as the first optical signal of the first predetermined wavelength.

12. The integrated optical coupler according to claim 10, wherein the coupler is adapted to simultaneously support a TE waveguide mode and a TM waveguide mode in the at least one integrated optical waveguide

13. The integrated optical coupler according to claim 10, wherein the coupler comprises a focusing grating.

14. The integrated optical coupler according to claim 1, wherein the grating structure comprises a non-uniform grating.

15. The integrated optical coupler according to claim 1, the integrated optical coupler being integrated in an integrated photonics circuit comprising the at least one integrated optical waveguide.

16. A method for optically coupling light between an optical element and at least one integrated optical waveguide, the method comprising coupling light to waveguide modes with different polarization with low polarization dependent loss.

17. The method according to claim 17, wherein the method comprises providing polarization splitting using a one-dimensional grating for an optical signal of a first predetermined wavelength, thereby maintaining orthogonal polarizations in the integrated optical waveguide.

18. The method according to claim 17, wherein the method comprises providing polarization splitting for a first optical signal of a first predetermined wavelength and coupling both polarizations forward or coupling both polarizations backward, using a two dimensional grating.

19. The method according to claim 19, wherein the method furthermore comprises providing polarization splitting for a second optical signal of a second predetermined wavelength and for coupling both polarizations for the second optical signal in the same direction as the first optical signal of the first predetermined wavelength.

20. The method according to claim 17, wherein the low polarization dependent loss is a loss smaller than 0.5 dB.

21. The integrated optical coupler according to claim 1, wherein a first of the waveguide modes is a Transverse Electric (TE) waveguide mode and a second of the waveguide modes is a Transverse Magnetic (TM) waveguide mode.
